(19) United States
(12) Patent Application Publication
(10) Pub. No.: US 2018/0250873 A1
(43) Pub. Date: Sep. 6, 2018

(54) HEATING PROCESS AND APPARATUS FOR FUSED DEPOSITION MODELING MACHINERY

(71) Applicants: Curtis Goffinski, Roseland, NJ (US); Hadrien Brisard, Rockford, IL (US); Lodovico E. Oldani, Rockford, IL (US); Nathan Haug, South Beloit, IL (US)

(72) Inventors: Curtis Goffinski, Roseland, NJ (US); Hadrien Brisard, Rockford, IL (US); Lodovico E. Oldani, Rockford, IL (US); Nathan Haug, South Beloit, IL (US)

(73) Assignee: Ingersoll Machine Tools, Inc., Rockford, IL (US)

(21) Appl. No.: 15/911,930

(22) Filed: Mar. 5, 2018

Related U.S. Application Data
(60) Provisional application No. 62/467,549, filed on Mar. 6, 2017.

(51) Int. Cl. B29C 64/118; B29C 47/00; B29C 64/30

(52) U.S. Cl. CPC B29C 64/118; B33Y 30/00; B29C 64/30; B29C 47/0014

(57) ABSTRACT

Process and apparatus, applicable to new or existing machinery for additive manufacturing, based on Fused Deposition of thermoplastic material deposited in subsequent layers one on top of another, wherein the process can be carried out preventing abnormal conditions in which the old layer about to receive a new layer has a surface temperature below a desired limit, that is below which bond strength is compromised and the resulting part defective. This feature is particularly useful in large envelope parts where the previous layer zone, which is about to receive a new layer thereon, has reached a surface temperature below said threshold limit. The apparatus comprises a heating system featuring multiple stationary heating elements, each one of them selectively powered in order to adjust delivered energy in direction and in intensity according to layer path and extruder speed.

### CROSS-REFERENCE TO RELATED PATENT APPLICATION

This patent application claims the benefit of U.S. Provisional Patent Application No. 62/467,549, filed Mar. 6, 2017, the entire teachings and disclosure of which are incorporated herein by reference thereto.

### FIELD OF THE INVENTION

This invention generally relates to Automatic Additive Manufacturing, and more particularly to apparatuses and methods for improving automatic fused deposition quality and productivity.

### BACKGROUND OF THE INVENTION

The additive manufacturing technology (e.g., 3D printing) is rapidly expanding, attracting interests for the development of new improved materials as well as more performing automated machines, used for the automatic fused deposition of materials to form any desired tridimensional shape. The most commonly used materials are the thermoplastic family while the automatic systems typically comprise an extruder head, spatially positionable by multiaxis positioners within a given work envelope and a fully integrated automatic material feed system.

Additive manufacturing uses a layer-based process to build any desired tridimensional part. The machinery typically takes data directly from CAD files (Computer Aided Design) and creates functional parts by extruding and depositing, layer after layer, fused material from its extruder nozzle, making possible to easily build even very complex parts.

In particular, each new layer is deposited on top of the previous one and has a cross section size and shape that depends on several key parameters such as material type, material temperature, extruder output flow, machine feeding speed and several others. Bead shape can also be manipulated by using post extrusion shaping rollers, following the extruder nozzle tip.

The multiple layer building process is aimed to produce parts which have to be ultimately stable in shape and meet a desired strength and durability.

The above requirement, in conjunction to the growing need to develop machinery with large work-envelopes (to increase part size) and faster manufacturing cycles (productivity=lb/hr of material deposited) are presently posing some challenges.

With so many process variables to be considered, one of the most challenging difficulties in order to maximize part accuracy, size, and manufacturing time is the difference of material temperature between the new layer being deposited versus the previous layer receiving the new one on top, hereinafter called as “old layer.”

In particular, if the old layer is still too warm, it is not in condition to receive the new one because it would not be able to geometrically maintain the shape (still too soft/insufficiently cured).

On the contrary, if the old layer is too cold, it will indeed be mechanically strong and ready to bear the new one but the mating surface between old and new layer would create a weak bond between the two layers and inflict a performance drop in terms of part strength (the joint between the two layers becomes a weak point).

While the first constraint (old layer too warm) can be easily managed by programming the machine, allocating sufficient time between old and new deposition, the second constraint (old layer too cold) is not easily managed and could be aggravated by undesired cycle interruptions.

Unarguably, the growing need to perform faster cycle times, increase material deposition flow rates but most importantly increasing part size, it is posing a challenge in terms of avoiding part structural weaknesses due to cold substrates.

Accordingly, there is a need in the art for a process and equipment capable of producing strong parts (parts with good strength between layers) regardless of the single layer perimeter length and/or part size (affecting time necessary to return on the same point, which is intimately correlated to old layer temperature drop). Embodiments of the present invention provide an apparatus and method that address these needs. These and other advantages of the invention, as well as additional inventive features, will be apparent from the description of the invention provided herein.

### BRIEF SUMMARY OF THE INVENTION

In one aspect, embodiments of the present invention provide means to bring the old layer surface temperature above what is determined to be, for a specific selected material, the minimum temperature threshold, below which weakness of the joint strength between old and new layer is experienced.

In another aspect, embodiments of the present invention provide said means capable to bring the old layer surface temperature focused on the surface which is about to receive a new layer, taking in consideration old layer location in space and new layer depositing speed.

Specifically, embodiments of the present invention provide an active method to avoid the deposition of a new material layer on an old layer in which the surface temperature of the old layer is below a certain minimum threshold limit. Further, embodiments of the present invention disclose a smart heating system comprising a plurality of individual heating means strategically arranged in an array around the extruder nozzle tip.

In embodiments, all heating elements are stationary and individually controllable in power. Thus, it is possible, in real time, to selectively activate only the one located along the location of the old layer about to receive a new layer and also to modulate the power according to the key process parameters, especially the new layer deposition feed rate (basically the heat delivered by each individual heating element to the old layer is controlled in direction and intensity). In other words, despite all heating element being stationary, heat can be modulated in intensity and direction aiming the energy toward where the head is heading in space.

In one particular aspect, an additive manufacturing machine is provided. An embodiment of such an additive manufacturing machine includes an extruder arm having an end plate. The machine also includes an extruder end effector carried by the extruder arm. The extruder end effector includes a heated extruder screw, a nozzle positioned at an end of the heated extruder screw, and a motor for driving the heated extruder screw to feed deposition material out of the nozzle. The machine also includes a heater unit surrounding the nozzle and configured and arranged to direct radiant heat energy towards a deposition material situated on a mold base.

In an embodiment according to this aspect, the heater unit comprises a plurality of heating elements. The plurality of heating elements may be arranged in a circular array such that the circular array defines a center point. The nozzle is coincident with the center point.

In an embodiment according to this aspect, the plurality of heating elements may also be arranged in a rectangular array.

In an embodiment according to this aspect, the heater unit is mounted to the end plate such that the heater unit is situated between the end plate and the deposition material layers.

In an embodiment according this aspect, the heater unit includes a plurality of heating elements. Each one of the plurality of heating elements is operable to direct radiant heat energy towards the deposition material layers independently of the remaining ones of the plurality of heating elements.

In another particular aspect, the invention provides an additive manufacturing machine. An embodiment of such a machine includes an extruder arm. The machine also includes an extruder end effector carried by the extruder arm. The extruder end effector includes a heated extruder screw, a nozzle positioned at an end of the heated extruder screw, and a motor for driving the heated extruder screw to feed deposition material out of the nozzle. The machine also includes a heater unit mounted to the extruder arm that includes a plurality of heating elements. Each one of the plurality of heating elements is operable to direct radiant heat energy towards the deposition material independently of the remaining ones of the plurality of heating elements.

In an embodiment according to this aspect, the plurality of heating elements are arranged in a circular array which defines a center point. The nozzle is coincident with this center point.

In an embodiment according to this aspect, the plurality of heating elements may be arranged in a rectangular array.

In an embodiment according to this aspect, the extruder arm includes an end plate. The heater unit is mounted to the end plate such that the heater unit is situated between the endplate and the deposition material layers.

In another particular aspect, the invention provides a method for forming an object using an additive manufacturing machine. An embodiment of such a method includes depositing a first layer using an extruder end effector carried by an extruder arm. The method also includes heating a region of the first layer using a heater unit carried by the extruder arm. The method also includes depositing a second layer using the extruder end effector on top of the heated region of the first layer.

In an embodiment according to this aspect, the step of heating the region of the first layer includes using at least one of a plurality of heating elements of the heater unit to direct radiant heat energy towards the first layer.

The step of heating the region of the first layer using at least one of a plurality of heating elements includes using at least one of the plurality of heating elements arranged in a circular array which defines a center point. The nozzle is coincident with the center point defined by the circular array.

In an embodiment according to this aspect, the step of heating the region of the first layer using at least one of a plurality of heating elements includes using at least one of the plurality of heating elements arranged in a rectangular array.

In an embodiment according this aspect, the step of heating a region of the first layer using a heating unit carried by the extruder arm includes using a heater unit which is situated between the endplate and the deposition material layers.

In an embodiment according to this aspect, the step of heating a region of the first layer using a heater unit carried by the extruder arm includes using a heater unit which includes a plurality of heating elements. Each one of the plurality of heating elements is operable to direct the radiant heat energy towards the deposition material layers independently of the remaining ones of the plurality of heating elements.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic view of the fused deposition modeling (FDM) layer based process, according to an exemplary embodiment;

FIG. 2 an isometric view of the device according to an embodiment of the present invention;

FIG. 3 is a side view of FIG. 2;

FIG. 4 is a plan view of a heater unit of the device of FIG. 2;

FIG. 5 is a schematic view illustrating how the device according to embodiments of the present invention operates; and

FIG. 6 is a plan view of an alternative configuration of the heater unit of FIG. 4.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

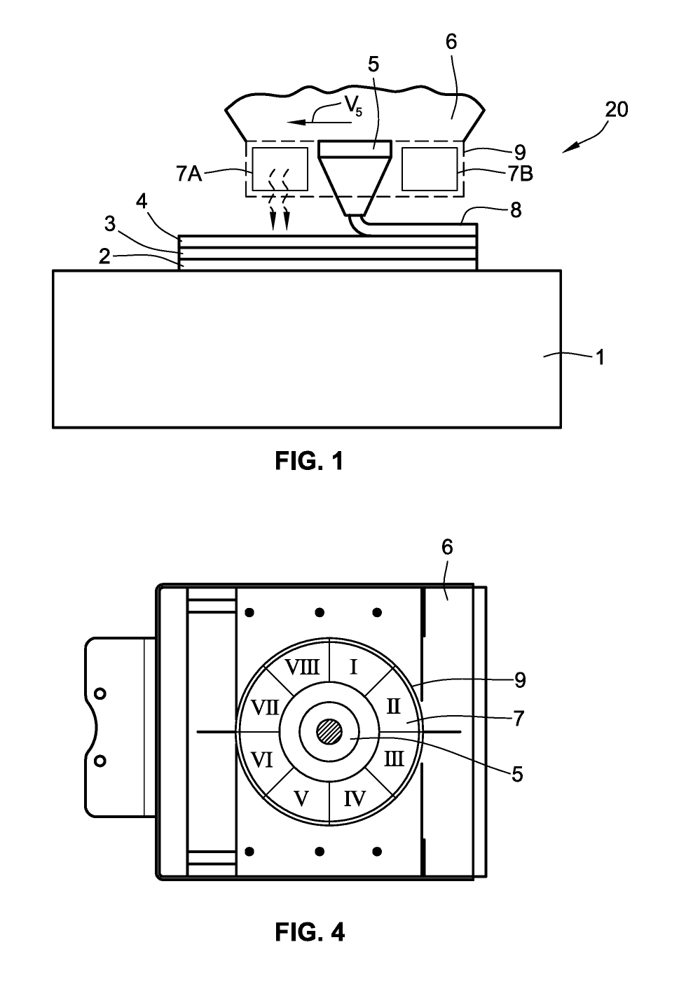

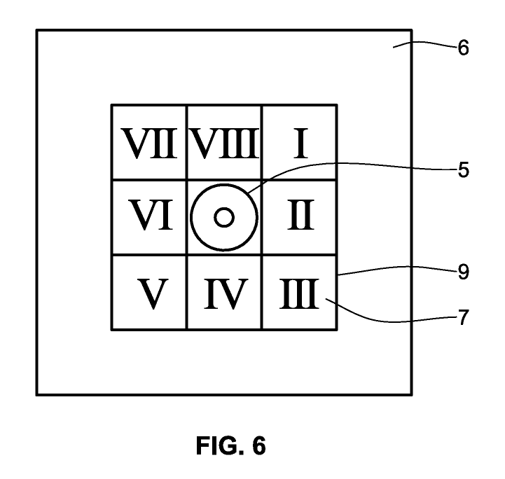

FIG. 1 schematically illustrates a portion of an additive manufacturing machine 20 and in particular schematically depicts how a part is being formed as a result of a multiple layers being deposited one on top of the other. FIG. 1 shows a mold base 1 and the material layers 2, 3, 4, and 8. Layer 4 is referred to as the “old” layer while layer 8 is the new layer being deposited as result of the extruder nozzle 5 pumping material out and travelling along the direction V5. The extruder end flange 6 provides mounting means to an annular heater unit 9 which contains a plurality of individual heating elements 7a, 7b arranged in a circular array (as shown in FIG. 3). The number, dimensions, and type of array of the individual heating elements is herein indicated as a polar array but could very well be a rectangular matrix as shown in FIG. 6, or other alternative arrangements.

In an exemplary embodiment, the new layer 8 is deposited at a material temperature of 260° C. A material temperature above 110° C. will lead to good bond strength. However, a material temperature in the range of room temperature to 100° C. will lead to insufficient new/old layer bond strength. In large structures, when a machine takes typically, e.g., more than 30 min to make one layer deposition, the old layer 4 is too cold and the joint strength is compromised. However, the presently disclosed smart heating system is capable of bring the surface of old layer 4 back above the 110° C. threshold for good bond strength.

FIGS. 2 and 3 provide a perspective view and a side view respectively of an extruder arm 22 of an additive manufacturing machine 20 (see FIG. 1) according to the teachings herein, carrying in space an extruder end-effector 24 which typically comprises a heated extruder screw 10, driven by a motor 11 which is capable of rotating at any desired speed in order to generate any desired material output flow rate according to the machine operating program. In an embodiment, granulated material is pneumatically fed to the screw and the melted material is fed out by a nozzle 5, usually located at tip of heated extruder screw. Although not shown in FIG. 2, it will be readily appreciated that machine 20 also may include a work table for carrying mold base 1, and a cabinet within which extruder arm 22 and the aforementioned work table are contained.

The extruder end effector end plate 6 holds the heater unit 9. In the specific embodiment depicted, heater unit 9 resembles an annular chamber containing a plurality of individual heating elements arranged in a circular array.

FIG. 3 shows schematically and in more detail a bottom view of the extruder end-effector 22 and the heater unit 9. In particular, the extruder nozzle 5 and the array of individual heating elements 7 are arranged in an array I-VIII. The heating elements themselves may take on any form of heating element which is configured for directing radiant heat energy at an object, e.g. radiant heating wires or plates, lasers, etc.

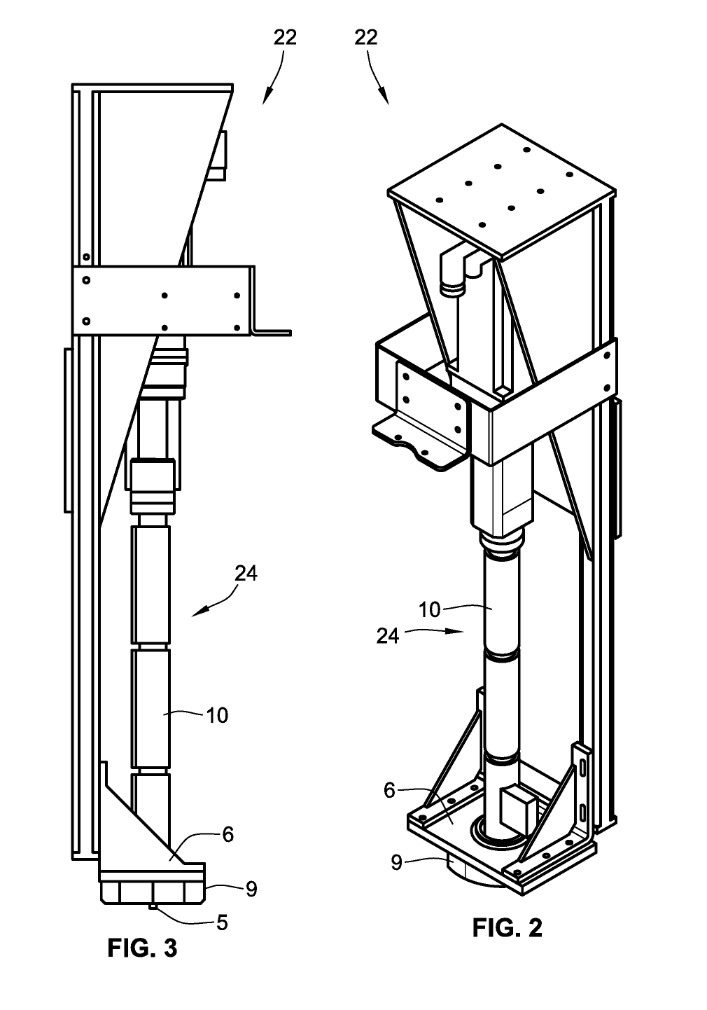

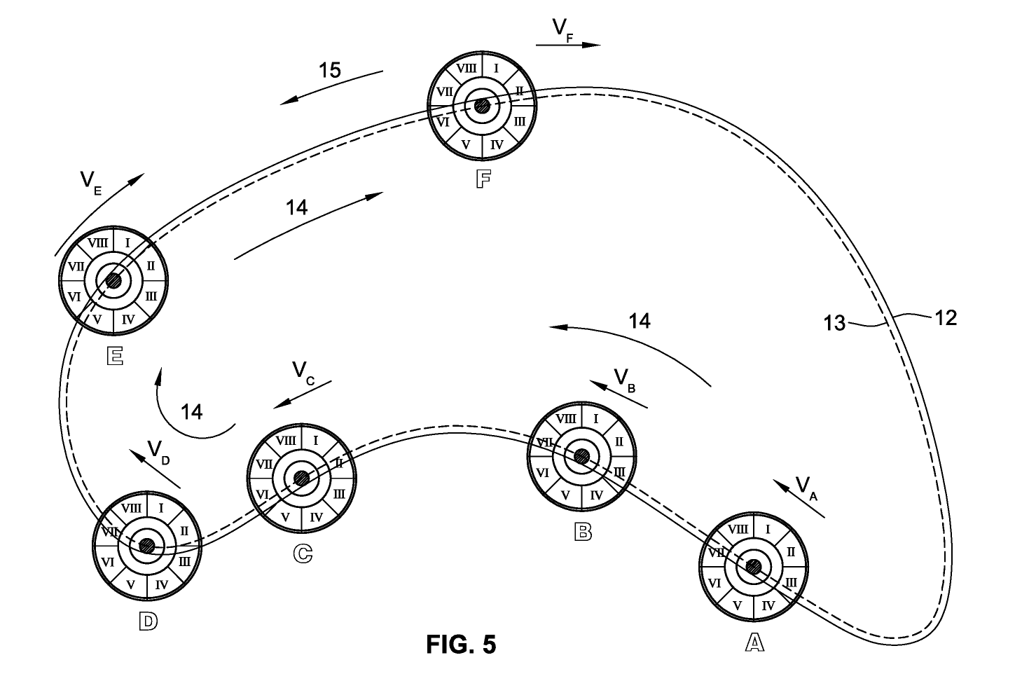

FIG. 4 schematically illustrates how the heating system 9 operates. In particular, FIG. 4 shows the old layer path 12 (solid line) and the new layer path 13 (dotted line), being deposited thereon as a result of the extruding end effector moving along the path 14.

FIG. 4 represents six different instantaneous positions A-F assumed by the end effector 24 while travelling along the path 13. In each individual position, the end effector 24 velocities Va through Vf are different in direction as well as in magnitude. In position A, only the heating element VII is powered and it is brought to a relatively high power percentage of its maximum power level because the nozzle is travelling at high speed level in a zone with low curvature.

In position C, elements VI and V are active as the path is close to both, but element VI is powered to a higher percentage of its maximum power than element V. Further, the combined heating power of elements VI and V is lower than the heating power of element VII at position A because the nozzle is travelling at a lower speed than at position A because the nozzle is approaching a tight curve and is slowing down.

In position F, heating element II is active.

When and if, the direction is reversed toward direction 15, the corresponding heating element, if any heat is necessary, would be the heating element VI.

In other embodiments, an on-off control logic can be considered instead of strategically modulating the power intensity. From the above, however, it will be clear that the heating elements are capable of operating independently of one another so that the appropriate heating element or elements are energized to a region of an old material layer just prior to a new material layer being deposited thereon. To this end, a controller may be utilized to control the operation of heater unit 9 as described above. Alternatively the same controller utilized to control the relative movement of the end-effector may incorporate the control logic necessary to effectuate the above. The term “controller” as used herein means the hardware, software, and firmware necessary to employ the above process.

Additionally, elements I-VIII shown may also be indicative of positions which a heating element could occupy. In this embodiment it is envisioned that heater unit 9 could comprise one or more heating elements mounted to a rotatable member, e.g. a motor driven rotatable plate mounted to end plate 6, or formed by end plate 6. This rotatable member may be indexed using the controller described herein, or a stand alone controller. In either case, rotation of the plate aligns the heating element or elements with the material to be heated, in similar or same manner as described above using a heating element array.

According to an alternative embodiment of the present invention, the heating system can rotate along an axis substantially parallel to the extruder screw 10, thus being able to selectively orientate the desired heating element toward the old layer path.

From what is described above, it is evident how the heating system according to embodiments of the present invention can secure the process condition that the old layer is sufficiently warm and consequently able to establish a mechanically strong bond with the new layer being deposited thereon.

Advantageously, the device features stationary heating elements in which each one is individually and strategically modulated in power in order to deliver an overall heat that is changing in direction and intensity, thus minimizing the energy delivered to the part. Also advantageously, the process prevents an old layer surface about to receive a new layer from being below a minimum temperature limit, thus allowing the manufacturing of stable and strong parts.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An additive manufacturing machine for a fused deposition process in which deposition material layers are layered upon a mold base and successively on one another, the additive manufacturing machine comprising:
an extruder arm having an end plate;
an extruder end-effector carried by the extruder arm, the extruder end-effector comprising:
a heated extruder screw;
a nozzle positioned at an end of the heated extruder screw; and
a motor for driving the heated extruder screw to feed deposition material out of said nozzle;
a heater unit surrounding said nozzle and configured and arranged to direct radiant heat energy towards deposition material layers on the mold base.

2. The additive manufacturing machine of claim 1, wherein the heater unit comprises a plurality of heating elements.

3. The additive manufacturing machine of claim 2, wherein the plurality of heating elements are arranged in a circular array, the circular array defining a center point.

4. The additive manufacturing machine of claim 3, wherein the nozzle is coincident with the center point.

5. The additive manufacturing machine of claim 2, wherein the plurality of heating elements are arranged in a rectangular array.

6. The additive manufacturing machine of claim 1, wherein the heater unit is mounted to the end plate such that the heater unit is situated between the end plate and the deposition material layers.

7. The additive manufacturing machine of claim 1, wherein the heater unit comprises a plurality of heating elements, wherein each one of the plurality of heating elements is operable to direct said radiant heat energy towards the deposition material layers independently of the remaining ones of the plurality of heating elements.

8. An additive manufacturing machine for a fused deposition process in which deposition material layers are layered upon a mold base and successively on one another, the additive manufacturing machine comprising:
an extruder arm;
an extruder end-effector carried by the extruder arm, the extruder end-effector comprising:
a heated extruder screw;
a nozzle positioned at an end of the heated extruder screw; and
a motor for driving the heated extruder screw to feed deposition material out of said nozzle;
a heater unit mounted to the extruder arm and comprising a plurality of heating elements, wherein each one of the plurality of heating elements is operable to direct said radiant heat energy towards the deposition material layers independently of the remaining ones of the plurality of heating elements.

9. The additive manufacturing machine of claim 8, wherein the plurality of heating elements are arranged in a circular array, the circular array defining a center point.

10. The additive manufacturing machine of claim 9, wherein the nozzle is coincident with the center point.

11. The additive manufacturing machine of claim 9, wherein the plurality of heating elements are arranged in a rectangular array.

12. The additive manufacturing machine of claim 8, wherein the extruder arm comprises an end plate.

13. The additive manufacturing machine of claim 8, wherein the heater unit is mounted to the end plate such that the heater unit is situated between the end plate and the deposition material layers.

14. A method for forming an object using an additive manufacturing machine, the method comprising:
depositing a first layer using an extruder end-effector carried by an extruder arm;
heating a region of the first layer using a heater unit carried by the extruder arm;
depositing a second layer using the extruder end-effector on top of the heated region of the first layer.

15. The method of claim 14 wherein the step of heating the region of the first layer includes using at least one of a plurality of heating elements of the heater unit to direct radiant heat energy towards the first layer.

16. The method of claim 15, wherein the step of heating the region of the first layer using at least one of a plurality of heating elements includes using at least one of the plurality of heating elements arranged in a circular array, the circular array defining a center point.

17. The method of claim 16, wherein the steps of depositing the first layer and the second layer include deposing the first and second layers using a nozzle of the extruder end effector, the nozzle coincident with the center point defined by the circular array.

18. The method of claim 15, wherein the step of heating the region of the first layer using at least one of a plurality of heating elements includes using at least one of the plurality of heating elements arranged in a rectangular array.

19. The method of claim 15, wherein the step of heating a region of the first layer using a heater unit carried by the extruder arm includes using a heater unit is situated between the end plate and the deposition material layers.

20. The method of claim 15, wherein the step of heating a region of the first layer using a heater unit carried by the extruder arm includes using a heater unit which comprises a plurality of heating elements, wherein each one of the plurality of heating elements is operable to direct said radiant heat energy towards the deposition material layers independently of the remaining ones of the plurality of heating elements.
